(19) United States
(12) Patent Application Publication
(10) Pub. No.: US 2005/0137938 A1
(43) Pub. Date: Jun. 23, 2005

(54) Method, system, and computer program product for eCommerce brokering of retail transaction data

(75) Inventors: Christopher Meyer, Cary, NC (US); Meenakshisundaram Venkatasubramaniam, Bridgewater, NJ (US); Filip J. Yeskel, Raleigh, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/741,371

(22) Filed: Dec. 19, 2003

(51) Int. Cl. G06F 17/60

(52) U.S. Cl. 705/26

(57) ABSTRACT

A method, system, and computer program product for allowing retailers to sell TLog data to third party purchasers using a standard eCommerce engine. The system collects TLog data, creates a user profile for a plurality of purchasers, offers customized TLog data for sale to the purchasers based upon criteria contained within their respective user profile, determines the appropriate price for the offered TLog data, packages and delivers the appropriate data in response to a purchase from a purchaser, and creates and stores a record of the transaction.

### TECHNICAL FIELD

The present invention relates generally to eCommerce, and, more specifically, to a method, system, and computer program product for eCommerce brokering of Retail Transaction Data.

### BACKGROUND

It is customary in many retail environments, such as supermarkets, to utilize a point-of-sale (POS) system having an optical scanner at designated checkout counters. Bar codes on objects or articles being purchased are read by the scanner so as to permit identification of the articles. In addition to providing efficient means of processing sales, these systems also allow retailers to collect a significant amount of information regarding the sales transaction. For example, it is easy to compile information regarding the price and quantities of all items sold, and, using a POS system, collect demographic information about the purchasers of the items sold. For example, today nearly every supermarket offers discounts to customers who possess a “bonus card.” These cards are issued by the store at no charge to customers who complete a short application soliciting demographic information about them (e.g., address, age, sex, marital status, etc.). Each time a “bonus card” holder purchases items, the bar code on the issued card is scanned. In doing so, the demographic information of the purchaser can be associated with the items purchased, allowing marketing and sales analysts to look for trends and to use this information to direct future sales and marketing strategies.

As an example, the vast amount of information collected can be cataloged and indexed to provide insight on buyer behavior and buying patterns. After the various information is collected at the POS, it can be compiled and cross referenced to extract additional information of interest. For example, information regarding items that are often purchased together, and by whom, can be extracted from the data collected at the POS and used to perform association analysis.

All of the above-described information can be derived from the data collected at the POS terminal. These data records are generally known as the “transaction log” or TLog data. Tlog data generally consists of a complete record of every event that occurs at the POS terminal. Clearly, the TLog information is very valuable to the retailers. There are, however, many other organizations that would place a high value on such TLog data. Manufacturers, advertising companies, and marketing consultants are among the many other types of organizations that would benefit from access to the TLog data. As a result, a business-to-business market is growing for the TLog data collected via POS systems.

The current process by which TLog can be obtained by prospective buyers is time and labor intensive. It requires manual compilation of data, as each data request is generally unique to the requester. For example, let us assume the Coca-Cola Bottling Co. (“Coke”) desires data on the demographics of the buyers of its products from Walmart Stores, Inc. (“Walmart”). A representative from Coke determines the exact information it desires (e.g., age and sex of Diet Coke buyers over a certain time period) and then contacts the proper person at Walmart with the request. The individual at Walmart must then go to the collected data and compile the requested information. The process is typically completed by the individual at Walmart sending the data, commonly via email with a spreadsheet attachment, to the requestor at Coke.

The process can become more complex if the requested data is subject to other constraints. In the example given, Walmart may have a contractual obligation with PepsiCo, Co. (“Pespi”) that prevents them from distributing information to third parties regarding sales of Pepsi products. In such an instance, the data compiled by the individual at Walmart must be examined, or filtered, to remove any information regarding Pepsi products before it can be sold to Coke. Additionally, the data is commonly “sanitized,” which is a process by which the data is modified to insure the privacy of the customers of the retailer. Sanitizing involves ensuring that personal information such as names, addresses, credit card numbers, etc. are removed before the TLog data is delivered to a third party. The compiling, filtering, sanitizing, and sending of the TLog data can be an extensive process, as is the process marketing the Tlog data (i.e., determining what prospective buyers would be interested in which TLog data items and at what price).

What is needed, therefore, is an efficient mechanism by which retailers in possession of TLog data can broker the price, availability, and delivery of selected and filtered portions of the available Tlog data to various business customers. This invention fulfils this need, among others.

### SUMMARY OF THE INVENTION

The present invention provides a method, system, and computer program product for allowing retailers to sell TLog data to third party purchasers using a standard eCommerce engine. The present invention provides an efficient means for a purchaser to access a catalog of TLog data through an on-line storefront, determine the price and availability of various TLog data, and place a request for such data. The system in accordance with the present invention authenticates the user, retrieves the requested data, filters and sanitizes the data as needed, and formats and delivers the information, all in accordance with previously established criteria for each user.

In an exemplary embodiment, the method in accordance with the present invention collects TLog data, creates a user profile for a plurality of purchasers, offers customized TLog data for sale to the purchasers based upon criteria contained within their respective user profile, determines the appropriate price for the offered TLog data, packages and delivers the appropriate data in response to a purchase from a purchaser, and creates and stores a record of the transaction.

### BRIEF DESCRIPTION OF DRAWINGS

FIG. 1 illustrates an exemplary environment in which the present invention operates;

FIG. 2 illustrates the functional modules in a system in accordance with the present invention; and

FIG. 3 is a flow chart illustrating an example of steps performed in a transaction for the purchase of TLog data in accordance with the present invention.

### DETAILED DESCRIPTION

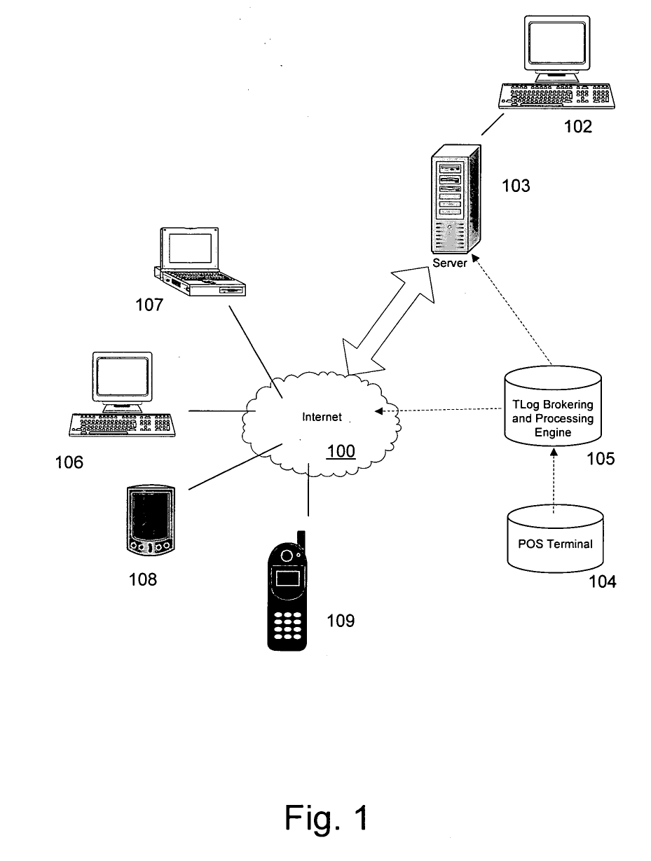

FIG. 1 illustrates a representative eCommerce environment in which the present invention may be practiced. The representative environment depicted in FIG. 1 comprises a server 103 on which eCommerce modules of the present invention reside. It should be appreciated, however, that the invention can be practiced using a single server as shown or alternatively using several servers, located at numerous locations, that are connected via a distributed network (e.g., the internet). In the exemplary embodiment, the eCommerce modules used to practice the present invention include IBM Websphere Commerce and IBM Websphere Digital Media Enabler (IBM Corp., Armonk, N.Y.). Websphere Commerce is an eCommerce engine designed to enable the sale of goods via a website interface, and Websphere Digital Media Enabler is a package that runs in conjunction with Websphere Commerce to facilitate the sale of the goods when the goods are themselves digital content.

The environment shown in FIG. 1 further comprises an administrative terminal 102 to allow access to the system by a system administrator for the purposes of updating the information contained in the eCommerce modules. The administrative terminal shown is exemplary in nature, as the administrative functions could alternatively be performed via a remote device connected via a distributed network (e.g., the internet).

The server 103 is connected to the internet 100 to allow for communication between purchasers of the TLog information and the seller of the TLog information. Purchasers can access the eCommerce system via one or more interface devices, such as workstations 106, laptops 107, PDAs 108, cellular phones 109, or any other device capable of accessing the internet.

The server 103 is also linked with POS terminal 104 at the retail location, via TLog Brokering and Processing Engine 105, to enable TLog data to be uploaded from the POS to the program modules on server 103. In the exemplary embodiment, a single POS terminal 104 is shown. In practice, however, the system in accordance with the present invention will likely comprise many sources of TLog data, e.g., data from various stores at various locations. Furthermore, in the exemplary embodiment, the server 103 is linked to the POS terminal 104 via the TLog Brokering and Processing Engine 105, although the connection between the server 103 and the POS terminal 104 through the TLog Brokering and Processing Engine 105 could alternatively travel via the internet.

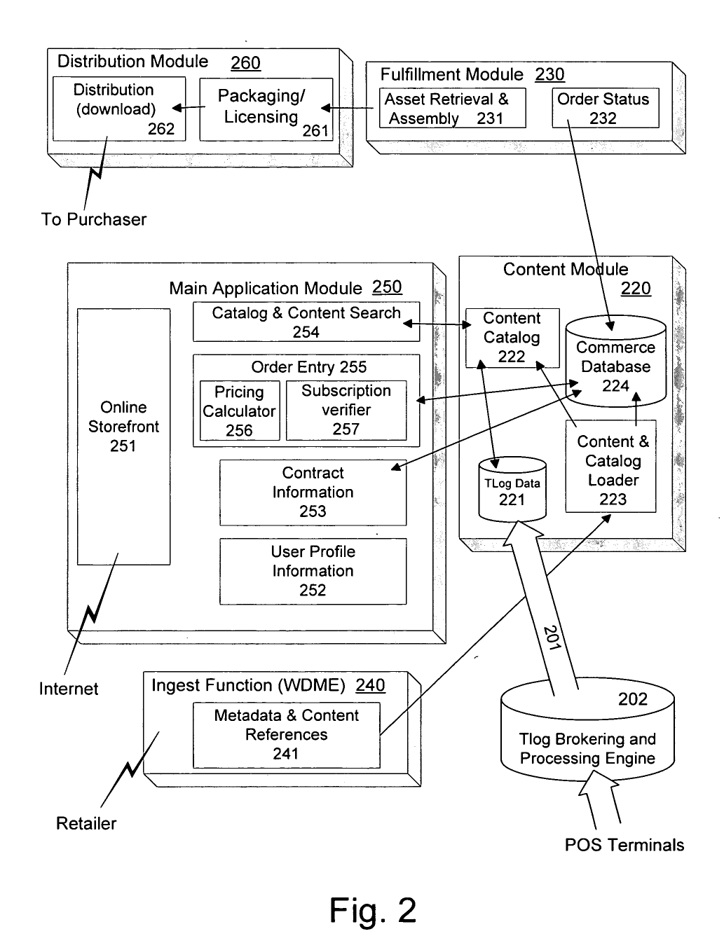

FIG. 2 illustrates the functional modules contained in a system in accordance with the present invention, and as depicts the paths on which data travels through the system. The present invention provides a method by which retailers can efficiently broker selected and filtered TLog data collected via POS terminals. The raw data is initially collected at one or more POS terminals. This data is supplied to the Content Module 220 via the TLog Brokering and Processing Engine 202 in data path 201. The data is stored within the Content Module 220 in a database, shown as TLog database 221, normally in an industry standard format such as Association for Retail Technology Standards (ARTS) data format, although other formats could also be used. The TLog data is collected at POS terminals on an ongoing basis, and is normally stored at the retail location (e.g., on a server in the store) prior to sending the data to the Content Module 220 via the TLog Brokering and Processing Engine 202. This data can be uploaded to the Content Module 220 periodically, for example, via a batch process run daily, or, preferably, the data can constantly be added using a “trickle” process throughout the day. The TLog data is provided to the Content Module 220 via a TLog Brokering and Processing engine. An example of a Brokering and Processing engine is IBM WBI TLog Processor Server. (IBM Corp., Armonk, N.Y.).

In the exemplary embodiment, purchasers interested in obtaining TLog data access the system via Online Storefront 251 contained within the Main Application Module 250. Online storefront 251 provides an interface that is appropriate to the user's browsing device (e.g., via a web page, WAP page, etc.) through which purchasers can visit the systems, identify themselves, and make purchases according to predetermined criteria. Before any prospective purchaser can purchase TLog data, he or she must first be registered for identification purposes. During the registration process, a user profile is created and stored in the Main Application Module 250 in a location designated for User Profile Information 252. The User Profile Information 252 contains information regarding who a user is and what information to which a user has access. Main Application Module 250 uses this information in conjunction with stored Contract Information 253 that is maintained for particular users or organizations. The Contract Information 253 is a record of the contract or business agreement that may exists for a particular user or organization. This information is used to determine, among other things, the price at which particular information is available. For example, a particular user may have a subscription agreement that allows for continued access to various information, or alternatively a user may be on a “buy per item” system where charges are assessed based upon the amount of data purchased. Additionally, the business agreement may also set forth the type or category of information that is available to a particular user or organization to which the user belongs.

In order to enable the stored TLog data to be cataloged and ordered in a manner that will allow users to search for desired data types, a set of Metadata and Content References 241 is entered by the retailer. For example, various groupings or views of the stored TLog data are possible. Some views may be a group of data about a certain product within a certain geographic region, while other views may be data regarding the sales of a certain product subject to a particular promotion. The Metadata and Content References 241 are used to assign sortable characteristics to the TLog data. The Metadata and Content References 241 can be entered by the retailer using the Ingest function (shown in FIG. 2 as Ingest Module 240) contained in Websphere Digital Media Enabler (WDME). The retailer accesses WDME using an administrative terminal (as shown in FIG. 1) or alternatively via the internet through any input device capable of accessing the internet.

Once the Metadata and Content References 241 are input via the Ingest Module 240, they are uploaded into the Content & Catalog Loader 223, which is part of the Content Module 220. The data in the Content & Catalog Loader 223 associates the actual TLog data records from TLog database 221 with the metadata in the Content Catalog 222. By associating each piece of TLog data with one or more metadata or content reference, searchable data is created that can be provided to purchasers via Online Storefront 251 contained in Main Application Module 250.

When a registered purchaser (one already having a user profile and contract information stored in Main Application Module 250) accesses the storefront, he or she can conduct a search for available TLog data (i.e., browse through the available data groupings in the content catalog) using the Catalog & Content Search Module 254 of Main Application 250. The actual set of data shown to the purchaser is limited according to the information in the purchaser's profile, and also in accordance with any constraints contained in the contract under which the purchaser is operating.

After selecting a desired set of TLog data records, the purchaser places an order via the Order Entry Component 255 of Main Application 250. In the exemplary embodiment, the Order Entry Component 255 determines the price of the records using Pricing Calculator 256 if the price of the data selected is undetermined. Additionally, the TLog data records requested can be checked at this point to determine if they covered by a subscription or pre-paid pricing plan using Subscription Verifier 257. Data that is not covered under a subscription must be paid for in some other means. Payment means are well known in eCommerce engines such as Websphere Commerce and include methods such as immediate payment via credit card or generation of an invoice for future payment.

After an order is placed, the actual data is retrieved through the Content Catalog 222 from TLog database 221. The data is sent to the Asset Retrieval & Assembly component 231 located within the Fulfillment Module 230. The Asset Retrieval & Assembly component 231 is analogous to the well known “shopping cart” used in eCommerce applications. Once the purchaser has completed selecting data, the selected data in the Asset Retrieval & Assembly component 231 is forwarded to the Distribution Module 260 for delivery. This is analogous to the “checkout” phase of well known eCommerce engines. Information regarding the order status is provided via an order Status Update component 232 of the Fulfillment Module 230 to the Commerce Database 224 contained within the Content Module 220. The Commerce Database 224 maintains information regarding all of the purchases that have been made. Information such as the records purchased, the price of the records, the purchaser of the records, the time of delivery of the records, and any other information that the retailer desires to track with regards to the sale of the TLog data are stored in the Commerce Database 224.

The Distribution Module 260 is responsible for providing the completed order to the purchaser. The TLog records are packaged in a format suitable for the purchaser's use and any necessary usage rights or licensing information is added (shown in FIG. 2 as the License & Content Packaging component 261 of the Distribution Module 260). The Download/Distribute component 262 makes the data available to the purchaser in the means desired by the purchaser. These means can include placing the TLog data in a file format suitable for downloading, writing the TLog data to a CD ROM for shipment to the purchaser, etc. Additionally, the TLog data can be encrypted for security during transmission and copy protected to prevent unauthorized duplication.

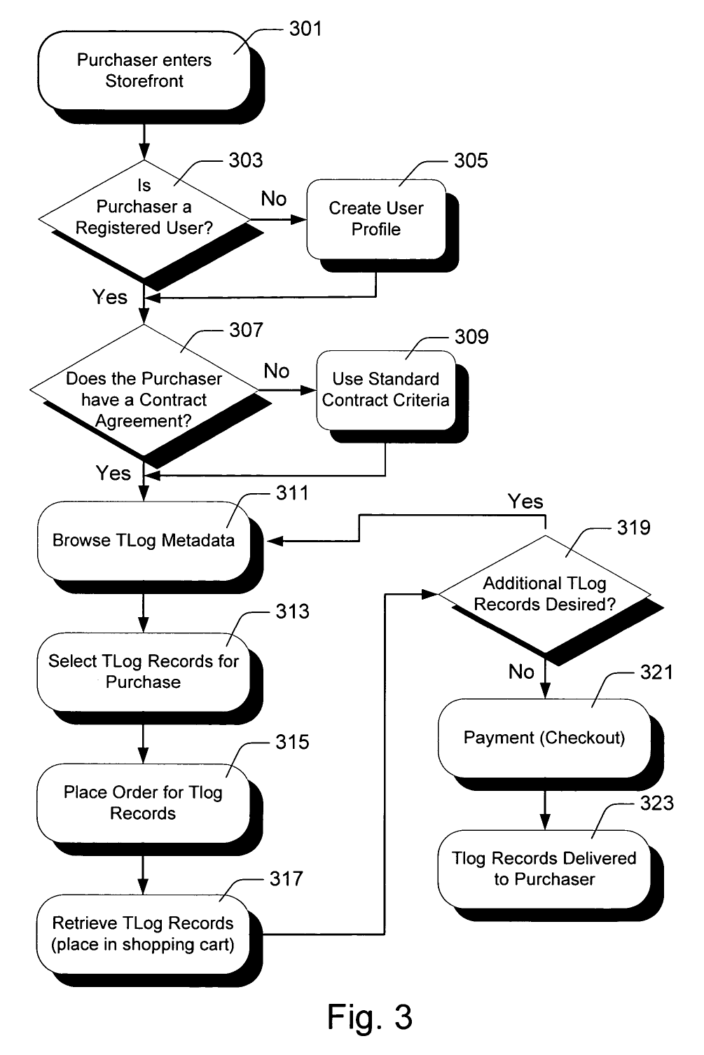

FIG. 3 is a flow chart illustrating the steps for an exemplary transaction in accordance with the method of the present invention. At step 301, a potential purchaser accesses the on-line storefront of the retailer. Upon entry to the storefront, the purchaser is checked to determine if he or she is a registered user, and thus already contains a user profile (step 303). If the purchaser is not a registered user, registration is required at this point (step 305). A user profile is created from the registration information. For the purposes of the exemplary transaction of FIG. 3, it is assumed that the purchaser may proceed immediately upon registration. In actuality, however, the information provided during the registration process may be subject to verification and further processing and a user password granting the purchaser access to the system would be sent to the purchaser following such verification.

After the purchaser is identified, a check is performed to determine if the purchaser is subject to special criteria because of a previously agreed upon business agreement or contract (step 307). If no contract exists, the purchaser will be subject to predetermined standard criteria for non-contract purchasers (step 309).

At this point, the purchaser can browse the metadata that describes the TLog records that are available for purchase by him or her (step 311). The metadata and the actual data have been filtered in accordance with the user profile for the user and any contract criteria the user to which the user is subject. The purchaser selects the TLog records he or she desires to purchase from those available (step 313). An order is placed to purchase the selected records (step 315).

Next, the order is processed by the system. In the exemplary embodiment, this involves retrieving the data from the TLog database and preparing it for distribution to the purchaser, e.g., placing the requested TLog data records in the purchaser's shopping cart, i.e., in the Asset Retrieval & Assembly component of the Fulfillment Module (step 317). Alternatively, the selected data may only be identified, but not be retrieved from the database and packaged, until the purchaser has completed all of his or her shopping. If the purchaser desires to purchase additional records, he or she can return at this point to the browse screen (step 319). If no additional TLog data records are desired, the purchase can proceed to the checkout process (step 321). The purchaser completes the sale by paying for the selected items using one of the available payment means, e.g., credit card, subscription, invoice, etc. The transaction is completed by delivering the purchased TLog data records to the purchaser in the manner previously selected by the purchaser during the registration process, e.g., downloading via the internet, sending of a CD ROM, etc. (step 325).

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage on a user workstation. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The system in accordance with the present invention provides an efficient means for retailers in possession of valuable TLog data to broker this data to interested third party purchasers. The present invention provides retailers with the means to efficiently offer for sale selected TLog data, filtered in accordance with a purchaser's profile, priced in accordance with a purchaser's profile, and packaged in a format in accordance with a purchaser's profile. It also enables companies who wish to obtain such TLog data to easily and efficiently obtain the information they desire. By eliminating the time consuming and labor intensive process previously employed to distribute TLog data, the present invention allows for TLog data to be obtained in greater volumes and at a lower cost. Additionally, the data can be obtained much more rapidly than in the past. The present invention allows for TLog data to become available for sale or purchase almost in real time.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

1. A method for eCommerce brokering of retail transaction data comprising the steps of:
collecting transaction log (TLog) data;
storing said TLog data;
providing access to said TLog data to a purchaser via an online interface;
retrieving selected TLog data records responsive to selections by said purchaser; and
delivering said selected TLog data record to said purchaser.

2. The method as set forth in claim 1, wherein said collecting step comprises:
obtaining TLog data at one or more point of sale (POS) terminals;
supplying said TLog data to a processing engine;
processing said TLog data via said processing engine place so as to format said TLog data in a format suitable for relational database storage; and
forwarding said TLog data in said suitable storage format to a database server for storage.

3. The method as set forth in claim 2, wherein said processing engine is WBI TLog Processor Server by IBM.

4. The method as set forth in claim 1, wherein said providing step comprises:
associating searchable metadata to the TLog data;
allowing access to said searchable metadata to said purchaser via said online storefront;
furnishing a search engine to allow said purchaser to browse said metadata; and
enabling said purchaser to select said TLog data by selecting said searchable metadata associated with said TLog data.

5. The method as set forth in claim 4, further comprising:
providing price information to said purchaser for said TLog data selected.

6. The method as set forth in claim 4, wherein said enabling step further comprises:
creating a user profile for a purchaser; and
filtering said TLog data to restrict said TLog data available for selection by said purchaser based on said user profile.

7. The method as set forth in claim 4, wherein said metadata is provided via an ingest function contained in Websphere Digital Media Enabler by IBM.

8. The method as set forth in claim 1 wherein said storing step comprises storing said TLog data in a database.

9. The method as set forth in claim 1 wherein said delivering step comprises:
packaging said Tlog data in a downloadable format; and
transferring said Tlog data via the internet.

12. A computer program product recorded on computer-readable medium for eCommerce brokering of retail transaction data comprising:
computer-readable means for collecting transaction log (TLog) data;
computer-readable means for storing said TLog data;
computer-readable means for providing access to said TLog data to a purchaser via an online interface;
computer-readable means for retrieving selected TLog data records responsive to selections by said purchaser; and
computer-readable means for delivering said selected TLog data record to said purchaser.

13. The computer program product as set forth in claim 12 wherein computer-readable means for collecting TLog data comprises:
computer-readable means for obtaining TLog data at one or more point of sale (POS) terminals;
computer-readable means for supplying said TLog data to a processing engine;
computer-readable means for processing said TLog data via said processing engine place so as to format said TLog data in a format suitable for relational database storage; and
computer-readable means for forwarding said TLog data in said suitable storage format to a database server for storage.

14. The computer program product as set forth in claim 12 wherein computer-readable means for providing access to said TLog data comprises:
computer-readable means for associating searchable metadata to the TLog data;
computer-readable means for allowing access to said searchable metadata to said purchaser via said. online storefront;
computer-readable means for furnishing a search engine to allow said purchaser to browse said metadata; and
computer-readable means for enabling said purchaser to select said TLog data by selecting said searchable metadata associated with said TLog data.

15. The computer program product as set forth in claim 14 wherein said computer-readable means for providing access to said TLog data further comprises:
computer-readable means for providing price information to said purchaser for said Tlog data selected.

16. The computer program product as set forth in claim 14 wherein said computer-readable means for providing access to said TLog data further comprises:
computer-readable means for filtering said TLog data to restrict said TLog data available for selection by said purchaser.

17. The computer program product as set forth in claim 12 wherein said computer-readable means for delivering said selected TLog data record to said purchaser comprises:
computer-readable means for packaging said TLog data in a downloadable format; and
computer-readable means for transferring said TLog data via the internet.

18. A system for eCommerce brokering of retail transaction data comprising:
a source of TLog data;
means for storing said TLog data;
means for entering searchable metadata associated with said TLog data;
means for accessing searchable metadata indicative of said TLog data by a purchaser; and
means for distributing said TLog data to said purchaser.

19. The system as set for in claim 18 wherein said means for storing said TLog data comprises a database.

20. The system as set forth in claim 18 wherein said means for entering searchable metadata comprises an ingest function contained in Websphere Digital Media Enabler by IBM.

21. The system as set forth in claim 18 wherein said means for accessing searchable metadata comprise:
an online storefront whereby a purchaser can access said system via the internet;
a set of user profile information determining which metadata accessible to said purchaser; and
a search module for searching said accessible metadata.

22. The system as set forth in claim 21 wherein said search module further comprises means for selecting said TLog data associated with said metadata provided during a search.

23. The system as set forth in claim 18 wherein said means for distributing said Llog data to said purchaser comprises:
a distribution module for packaging said TLog data in a downloadable format; and
a download path for allowing said TLog data to be transferred to said purchaser via the internet.
